(19) United States
(12) Patent Application Publication
(10) Pub. No.: US 2003/0150167 A1
(43) Pub. Date: Aug. 14, 2003

(54) Window elevator system with steel cord reinforced belt

(76) Inventors: Luc Bourgois, Desselgem (BE); Paul Bruyneel, Ooigem (BE); Bert Vanderbeken, Waregem (BE)

Correspondence Address: FOLEY AND LARDNER, SUITE 500, 3000 K STREET NW, WASHINGTON, DC, 20007, US

(21) Appl. No.: 10/275,651

(22) PCT Filed: Apr. 19, 2001
(86) PCT No.: PCT/EP01/04449

(30) Foreign Application Priority Data
May 11, 2000 (EP) 00201691.3

(51) Int. Cl. E05F 11/48

(52) U.S. Cl. 49/352

(57) ABSTRACT

A window elevator system (10) is adapted to be built inside the door of a motor vehicle comprises a driving drum (12), a transmission member (14) and a window (16). The transmission member (14) transmits the movement from the drum to the window. The transmission member is comprises a belt (14). The belt (14) is reinforced by one or more steel cords (28, 38)): at least one of said steel cords is of one of following types which has an improved fatigue resistance: (i) The steel cord (28) comprises more than one strand (30, 34) and each of 18 the strands (30, 34) comprises steel filaments (32, 36) with a diameter less than or equal to 0.12 mm, at least five strands (34) are arranged at the circumferential side of the cord (28); (ii) The steel cord (38) comprises more than one filament (40, 42, 44) and each of the filaments has a diameter less than or equal to 0.12 mm, at least five filaments (44) are arranged at the circumferential side of said cord.

### FIELD OF THE INVENTION

The present invention relates to a window elevator system adapted to be built inside the door of a motor vehicle. The system comprises a driving drum, a transmission member and a window. The transmission member transmits the movement from the drum to the window.

### BACKGROUND OF THE INVENTION

Such window elevator systems are well known in the art.

In the doors of present and future motor vehicles more and more functions are built. Loudspeakers of a stereo system and side air bag systems are examples hereof. A consequence is that the components of a window elevator system are getting smaller and smaller, leading—amongst others—to small diameter pulleys, which guide the transmission member. Another consequence is that the transmission member gets longer and longer, since it has to make a detour around the newly built in function systems. Next to this miniaturization, higher and higher performances are expected from a window elevator system. A longer lifetime, complete recyclability, a low level of creep, a low elongation and operativeness under temperatures ranging from −30° C. to +90° C. are the most important performance requirements. With respect to the longer lifetime, the transmission member is the most vulnerable part. A longer lifetime can be reached if the transmission member has both a high fatigue resistance and a high corrosion resistance.

The higher fatigue resistance is a severe requirement having regard to the above-mentioned miniaturization. Indeed the smaller diameter pulleys make it difficult to reach the same level of fatigue resistance let alone a higher level of fatigue resistance.

With respect to the corrosion resistance, a salt spray test of substantially more than 100 hours is a minimum requirement.

Another problem is that measures taken to increase the corrosion resistance often decrease the fatigue resistance or vice versa. As a matter of example only, if the transmission member is a steel cord, a thick zinc coating increases the corrosion resistance but decreases the fatigue resistance and vice versa.

U.S. Pat. No. 5,076,014 discloses a window elevator system where the transmission member is a perforated or a toothed belt. U.S. Pat. No. 5,076,014 is, however, vague with respect to the type of reinforcement.

### SUMMARY OF THE INVENTION

It is an object of the present invention to provide a window elevator system, which avoids the drawbacks of the prior art.

It is a further object of the present invention to provide a window elevator system where the transmission member meets the requirements of a high fatigue resistance, a high corrosion resistance, a low elongation, a low level of creep and a complete recyclability.

According to the present invention there is provided a window elevator system adapted to be built inside the door of a motor vehicle. The system comprises a driving drum, a transmission member and a window. The transmission member transmits the movement from the drum to the window.

The transmission member is constituted by a belt, which is reinforced by one or more steel cords.

These steel cords either belong to one of the following types of steel cords:

(i) a particular multi-strand steel cord, namely a steel cord with more than one strand; each of the strands comprises steel filaments with a diameter less than or equal to 0.12 mm, e.g. less than or equal to 0.10 mm; at least five strands are arranged at the circumferential side of said cord in order to obtain the required level of fatigue resistance;

(ii) a particular single-strand steel cord, namely a steel cord out of one strand comprising more than one filament, each of the filaments has a diameter less than or equal to 0.12 mm, at least five filaments are arranged at the circumferential side of said cord in order to obtain the required level of fatigue resistance.

The belt may be a toothed belt, a partially toothed belt or a non-toothed belt such as a flat ribbon.

The material of the belt may be rubber or a thermoplastic elastomer such as polyurethane. Other suitable thermoplastic elastomers are thermoplastic polyolefin homopolymers or copolymers, olefinic rubbers, block-copolymers of styrene/conjugated diene/styrene and/or its fully or partially hydrogenated derivative, optionally compounded with a thermoplastic polyolefin homopolymer or copolymer, or blends of the foregoing. Such thermoplastic elastomers are described in more detail in WO-A-99155793 (Advanced Elastomer Systems and N.V. Bekaert S.A.).

The inventors have tested a number of potential reinforcements of the belts.

Glass fiber reinforced belts perform well with respect to elongation and creep, but perform not so well with respect to breaking load and fatigue resistance. Moreover they are difficult to manufacture since they break easily and do not allow 100% recyclability.

Aramid fiber reinforced belts perform well with respect to breaking load, but have a relatively high level of creep and do not allow 100% recyclability.

Steel cord reinforced belts perform well with respect to breaking load, elongation and (absence of) creep. They do not impose substantial difficulties in their manufacture. They allow a complete recyclability since they are easy to separate from the matrix material. The corrosion resistance of the steel cords in the belt can be improved by coating the steel cords with zinc or with a zinc alloy coating and by improving the adhesion between the steel cord and the matrix material of the belt.

However, not all steel cords perform well with respect to the high level of fatigue resistance required for the future transmission members.

A well-known 3×3 steel cord (three strands with three filaments in each strand) with steel filaments of only 0.08 mm does not perform well in fatigue tests which simulate the circumstances of the future window elevator systems.

An improved and acceptable performance has been noted in case of the above-mentioned steel cord types (i) and (ii). An explanation herefore can be found in the fact that these steel cord types (i) and (ii) all have a much rounder cross-section than a 3×3 steel cord since they have five or more strands or filaments in their outer layer, unlike a 3×3 steel cord which has only three strands in its outer layer and looks more like a polygon.

Examples of steel cords that fall under type (i) are:

7×3×0.06

7×7×0.10

19+8×7.

Examples of steel cords that fall under type (ii) are:

3+9

1×12 compact cord

4+10+16

3+8+13

1+6+11.

### BRIEF DESCRIPTION OF THE DRAWINGS

The invention will now be described into more detail with reference to the accompanying drawings wherein

FIG. 1 gives a schematic view of a window elevator system;

FIG. 2 gives a longitudinal section of a belt of a window elevator system;

FIG. 3 shows a cross-section of a belt in a window elevator system;

FIG. 4 shows a cross-section of a steel cord of a first type (i) suitable for reinforcement of a belt;

FIG. 5 shows a cross-section of a steel cord of a second type (ii) suitable for reinforcement of a belt.

### DESCRIPTION OF THE PREFERRED EMBODIMENTS OF THE INVENTION

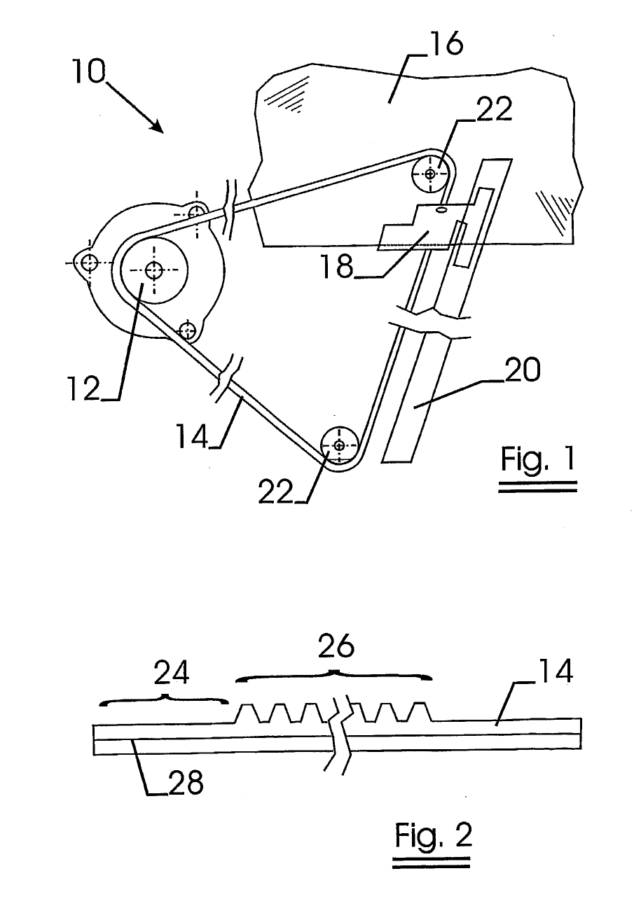

FIG. 1 shows schematically the essential parts of a window elevator system 10 according to the invention. The driving drum 12 may be electrically driven or may be manually operated. The rotational movement of driving drum 12 is translated in a to and fro movement of belt 14 which is the transmission member. The to and fro movement of belt 14 is in its turn translated in an upward and downward movement of window 16.

Belt 14 may be toothed at least for that part which may come in engagement with driving drum 12.

As an alternative embodiment to a toothed belt, the belt may be in the form of a flat ribbon (not shown) which is wound around driving drum 12 and is held against the driving drum by means of pressure rolls under a spring tension.

Returning to FIG. 1, a carriage 18 is attached to the belt 14 and carries the window in its upward and downward movement thereby helped by means of a guide 20.

One or more pulleys 22 guide the belt 14 in its traject inside a door of a motor vehicle.

FIG. 2 shows a longitudinal section of belt 14. Part 24 of the belt 14, which does not come in contact with driving drum 12, is not toothed. Part 26 of the belt 14, which may come in engagement with driving drum 12, is toothed. Belt 14 is reinforced by one or more steel cords 28, which run parallel in a longitudinal direction. A belt 14 can be made in a conventional extrusion process.

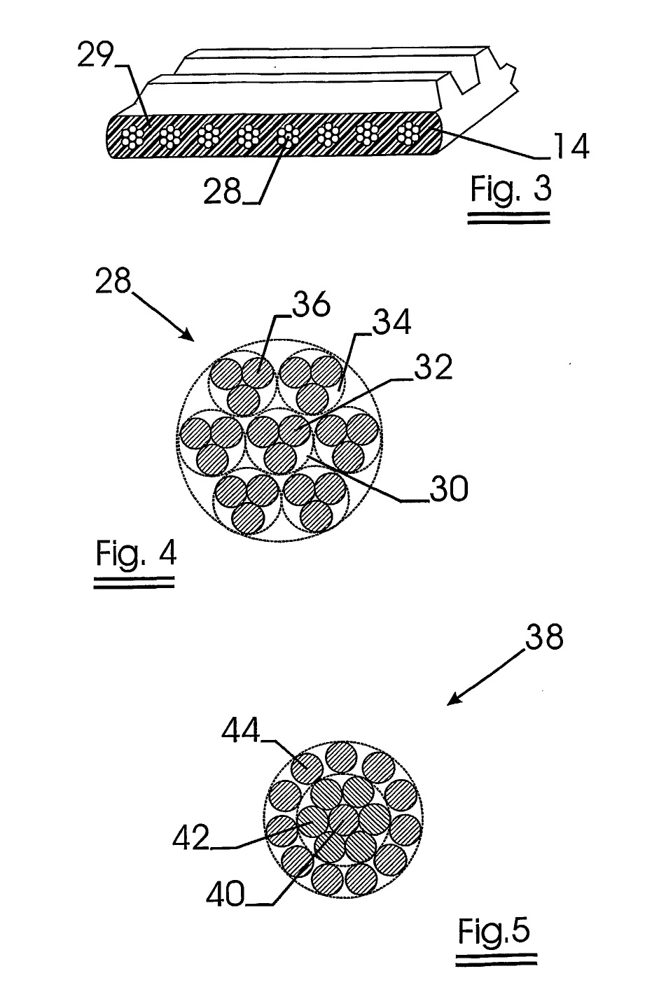

FIG. 3 shows the cross-section of belt 14. Several steel cords 28 arranged in a parallel relationship adjacent to each other reinforce belt 14. The matrix material 29 of the belt 14 may be of polyurethane.

FIG. 4 shows the cross-section of a steel cord 28 of the first type (i). Cord 28 corresponds to the formula

7×3×0.06 or 3×0.06+6×(3×0.06)

and comprises a core strand 30 with three filaments 32 and six outer strands 34 surrounding the core strand 30. Each outer strand has three filaments 36. The diameter of filaments 32 and 36 is 0.06 mm.

FIG. 5 shows the cross-section of a steel cord 38 of the second type (ii). Cord 38 corresponds to formula

1×0.13+6×0.13+11×0.12

and comprises a core filament 40 of 0.13 mm, six intermediate filaments 42 of 0.13 mm surrounding the core, and eleven outer filaments 44 of 0.12 mm surrounding the intermediate filaments 42. This cord has shown to have a high level of fatigue resistance.

Steel cords 28 and 38 can be manufactured by means of conventional double-twisters (bunchers) or by means of conventional tubular rotary machines (“cabling” apparatus) starting from hard drawn steel filaments. The steel filaments preferably have a steel composition which is along the following lines: a carbon content ranging from 0.50% to 1.05%, preferably from 0.80% to 1.05%, a manganese content ranging from 0.10% to 1.10%, a silicon content ranging from 0.10% to 0.90%, sulfur and phosphorous contents being limited to 0.15%, preferably to 0.10%; additional micro-alloying elements such as chromium (up to 0.20%-0.40%), copper (up to 0.20%) and vanadium (up to 0.30%) may be added. Having regard to the small diameter (filament diameters below 0.12 mm, e.g. below 0.10 mm), the number and particularly the size of any hard inclusions in the steel is kept as small as possible.

A number of polyurethane belts all with different reinforcements have been compared with respect to their mechanical properties. The tables hereunder summarize the results.

TABLE 1

| Type of reinforcement | Elongation after 5 | Creep |
|---|---|---|
| (12 cords per belt) ▾ | million cycles (mm) | behavior |
| Glass fiber 0.34 | 0.5 | Stable |
| Aramid fiber AT5/990 | 1.9 | Increasing |
| 1670*1 | | |
| Steel cord 3 × 3 × 0.08 | 1.0 | Stable |
| Invention steel cord | 0.8 | Stable |
| reinforcement 7 × 3 × 0.06 | | |

The elongation after 5 million cycles gives an indication of the amount of creep occurred.

The creep behavior indicates whether or not that elongation still increasing after 5 million cycles. Only the aramid fibers give a continuously increasing trend.

TABLE 2

| | Breaking | Breaking | Number of |
|---|---|---|---|
| Type of reinforcement | load before | load after | cycles before |
| ▾ | fatigue (N) | fatigue (N) | fracture |
| Glass fiber 0.34 | 1120 | — | 2 fractures at |
| | | | 300 cycli |
| Aramid fiber AT5/990 | 3314 | 3314 | >30,000 |
| 1670*1 | | | |
| Steel cord 3 × 3 × 0.12 | 2144 | — | 2 fractures at |
| | | | 3000 cycli |
| Invention steel cord | 1005 | 1005 | >30,000 |
| reinforcement | | | |
| 7 × 3 × 0.06 | | | |

The fatigue test was constituted by subjecting a reinforced belt to a number of bendings around a small pulley (diameter about 19 mm) under a varying tensile load.

For both aramid and 7×3×0.06 reinforced belts the test was stopped after 30 000 cycli. These reinforcements do not show any particular reduction in breaking load after 30 000 cycli.

1. A window elevator system adapted to be built inside the door of a motor vehicle, said system comprising a driving drum, a transmission member and a window,
said transmission member transmitting the movement from said drum to said window,
said transmission member comprising a belt, said belt being reinforced by one or more steel cords, at least one of said steel cords comprising more than one strand, each of said strands comprising steel filaments with a diameter less than or equal to 0.12 mm, at least five strands being arranged at the circumferential side of said cord.

2. A window elevator system adapted to be built inside the door of a motor vehicle, said system comprising a driving drum, a transmission member and a window,
said transmission member transmitting the movement from said drum to said window,
said transmission member comprising a belt, said belt being reinforced by one or more steel cords, at least one of said steel cords comprising more than one filament, each of said filaments having a diameter less than or equal to 0.12 mm, at least five filaments being arranged at the circumferential side of said cord.

3. A system according to any one of the preceding claims wherein said belt is a toothed belt.

4. A system according to any one of the preceding claims wherein said belt is made of rubber.

5. A system according to any one of claims 1 to 3 wherein said belt is made of a thermoplastic elastomer.
